(19) United States
(12) Patent Application Publication
(10) Pub. No.: US 2021/0212484 A1
(43) Pub. Date: Jul. 15, 2021

(54) DRINKING DEVICE WITH IMAGE EFFECT

(71) Applicant: Ariztlan Federico Lopez, Tucson, AZ (US)

(72) Inventor: Ariztlan Federico Lopez, Tucson, AZ (US)

(21) Appl. No.: 16/741,543

(22) Filed: Jan. 13, 2020

(51) Int. Cl. A47G 19/22; F21V 33/00

(52) U.S. Cl. CPC A47G 19/2227; F21V 33/0036; F21Y 2115/10; A47G 2200/08; A47G 2019/2238

(57) ABSTRACT

Disclosed is a drinking device comprising an image element configured to produce a lighted image against the drinking device.

### TECHNICAL FIELD

This disclosure is generally directed to drinking devices.

### BACKGROUND

Drinking devices, such as bottles (including baby bottles, and sports bottles), cups, sippy cups, mugs, glasses, shot glasses, other drinkware, and the like commonly incorporate various elements such as lids, spouts, handles, decorative artwork, other fanciful elements, etc. Such additional elements may provide secondary functionality and/or enhanced appearance, which increases the appeal of the drinking vessel to the consumer. As such, novel features which provide ancillary benefits are desirable for increasing product appeal and sales of drinking devices.

### SUMMARY

Various inventive features are described below that can each be used independently of one another or in combination with other features.

In accordance with various embodiments, disclosed is a drinking device comprising: a container configured to contain a liquid, and providing an opening from which said liquid can exit the container, the container being formed from at least one container wall having an outer surface; an image element, configured to emit a defined image, the image element attached or configured for attachment to the outer surface of said container, such that said liquid within said container is prevented from contact with said image element, the image element including a light source, a power source configured to power the light source, and an image overlay configured to combine with the light source in order to produce the image, wherein said image or design may be emitted while the drinking device is filled with a liquid, and while a user drinks the liquid. In some embodiments, the image comprises at least one of a textual image, a logo, picture, sign, symbol, or combinations thereof. In some embodiments, the image is configured to project onto a surface outside of the drinking device. In further embodiments, the image overlay is removable and/or interchangeable. In yet further embodiments the image overlay comprises a film.

In some embodiments, the image element further comprises at least one optical element including at least one of a lens, reflector, or condenser. In some embodiments, the image overlay comprises a mask configured to fit over at least a portion of the drinking device. In further embodiments, the mask is formed from a flexible material. In further embodiments, the mask is formed from a metal, plastic, or rubber material. In yet further embodiments, the mask comprises an opaque sheet having a cutout, wherein the image is formed according to the cutout. In some embodiments, the mask comprises an opaque form of the image. In some embodiments, the device further comprises a retaining element for encapsulating at least a portion of said image element, the retaining element including at least one retainer wall surrounding at least a portion of said container wall, said retainer wall being parallel to said container wall and forming a compartment against the outer surface of said container wall. In some embodiments, the light source comprises LED lights.

According to various embodiments, disclosed is a drinking device comprising: a container configured to contain a liquid, and providing an opening from which said liquid can exit the container, the container being formed from at least one container wall having an outer surface; an image element, configured to emit a defined image comprising at least one of a textual image, a logo, picture, sign, symbol, or combinations thereof, the image element attached or configured for attachment to the outer surface of said container, such that said liquid within said container is prevented from contact with said image element, the image element including a light source, and a power source configured to power the light source, wherein said image or design may be emitted while the drinking device is filled with a liquid, and while a user drinks the liquid. In some embodiments, the image is configured to project onto a surface outside of the drinking device. In further embodiments, the image element further comprises at least one optical element including at least one of a lens, reflector, or condenser. In some embodiments, the device further comprises a retaining element for encapsulating at least a portion of said image element, the retaining element including at least one retainer wall surrounding at least a portion of said container wall, said retainer wall being parallel to said container wall and forming a compartment against the outer surface of said container wall. In some embodiments, the light source comprises LED lights.

According to various embodiments, disclosed is a wrap around lighting element which may comprise: a band, configured to wrap around an object, the band comprising a lighting element. In some embodiments, the wrap around lighting element further comprises a closure element, and a power source for the lighting element, wherein the lighting element comprises LED lights attached to the band. In some embodiments, the wrap around lighting element may further comprise an image element.

Also disclosed according to various embodiments, is a drinking method comprising: attaching an image overlay to a drinking device comprising a container configured to contain a liquid, wherein the drinking device is configured to emit an image via said image overlay, wherein said image may be emitted while the drinking device is filled with a liquid, and while a user drinks the liquid. In embodiments, the drinking device further comprises a light source and a power source configured to power the light source, wherein the image overlay is configured to combine with the light source in order to produce said image.

### BRIEF DESCRIPTION OF THE FIGURES

The drawings described herein are for illustration purposes only and are not intended to limit the scope of the present disclosure in any way. The present disclosure will become more fully understood from the detailed description and the accompanying drawings wherein:

FIGS. 1A-C illustrate a drinking device including an image element, configured to produce a lighted image, in accordance with various embodiments;

FIG. 1A illustrates the drinking device, with the image emanating from a bottom surface of a container of the device;

FIG. 1B illustrates the drinking device, with the image emanating from a side surface of the container of the device;

FIG. 1C illustrates the drinking device, with the image emanating from the bottom and side surfaces of the container of the device;

FIGS. 2 A-E illustrate various drinking devices which may incorporate the image element shown in FIGS. 1A-C, according to various embodiments;

FIG. 2A shows a baby bottle with the image element at a bottom surface of the bottle;

FIG. 2B shows a lidded cup with the image element at a bottom surface of the cup;

FIG. 2C shows a mug with the image element at bottom and side surfaces of the mug;

FIG. 2D shows a sports bottle with the image element at a side surface of the bottle;

FIG. 2E shows a wine glass with the image element at a bottom surface of the glass;

FIG. 3 is a schematic of an image element, according to an exemplary embodiment, which includes an overlay comprising an image film;

FIGS. 4A-E are examples of an image element which includes an overlay comprising a mask, in accordance with various embodiments;

FIG. 4A shows an overlay/mask included an image cutout within an opaque sheet;

FIG. 4B shows the mask of FIG. 4A attached to a cup;

FIG. 4C shows a mask similar to the mask of FIG. 4A, but with reversed transparency, comprising a transparent sheet, and opaque image.

FIG. 4D illustrates a mask comprising a stand alone opaque image, according to various embodiments;

FIG. 4E illustrates the mask of FIG. 4D attached to a cup;

FIG. 5 illustrates a drinking method;

FIG. 6A illustrates a sleeve type mask which comprises a wrap around band with light source, according to various embodiments;

FIG. 6B illustrates the mask of FIG. 6A wrapped around a bottle.

FIG. 6C illustrates the mask of FIG. 6A wrapped around a Sippy cup;

FIG. 6D illustrates the mask of FIG. 6A wrapped around a user's arm;

FIG. 6E illustrates the mask of FIG. 6A wrapped around a flower pot;

FIG. 6F illustrates the mask of FIG. 6A wrapped around a guitar neck; and

FIG. 6G illustrates the mask of FIG. 6A wrapped around a pen.

### DETAILED DESCRIPTION

Unless specifically stated otherwise, references to “a”, “an”, and/or “the” may include one or more than one and that reference to an item in the singular may also include the item in the plural. It is to be understood that the phrases “one or more” and “at least one” refer, for example, to instances in which one of the subsequently described circumstances occurs, and to instances in which more than one of the subsequently described circumstances occurs.

All ranges and ratio limits disclosed herein may be combined. Ranges disclosed herein include, unless specifically indicated, all endpoints and intermediate values.

The term “optional” or “optionally” refer, for example, to instances in which subsequently described circumstances may or may not occur, and include instances in which the circumstance occurs and instances in which the circumstanced do not occur. The term “about” used in connection with a quantity is inclusive of the stated value and has the meaning dictated by the context (for example, it includes at least the degree of error associated with the measurement of the particular quantity). When used in the context of a range, the term “about” should also be considered as disclosing the range defined by the absolute values of the two endpoints. For example, the range “from about 2 to about 4” also discloses the range “from 2 to 4”.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical, and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. Materials for attachment may include, but is not limited to adhesive material, nails, staples, tape, etc.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more”. Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

With reference to the accompanying figures, disclosed is a drinking system, providing a drinking device 100 comprising: a container 102 configured to contain a liquid 104, and providing an opening 106 from which the liquid 104 can exit the container 102. According to various embodiments, the container 102 is formed from at least one container wall 103 having an outer surface 112. According to various embodiments, the drinking device 100 further comprise an image element 110 attached or configured for attachment to an outer surface 112 of the container 102, such that a liquid within the container is prevented from contact with the image element. In other words, the image element is kept isolated from the liquid in the container 102 (and/or liquid exiting the container 102 as the liquid is being drunk by a user). According to various embodiments, the image element 110 is configured to emit a defined image 114, such that the image 114 may be emitted while the drinking device 100 is filled with a liquid, and while a user drinks the liquid. In embodiments, the image 114 may further be projected onto a nearby surface.

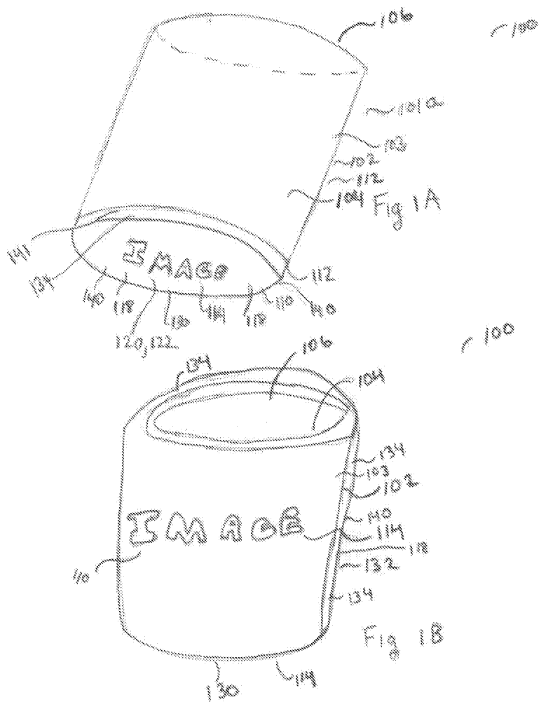

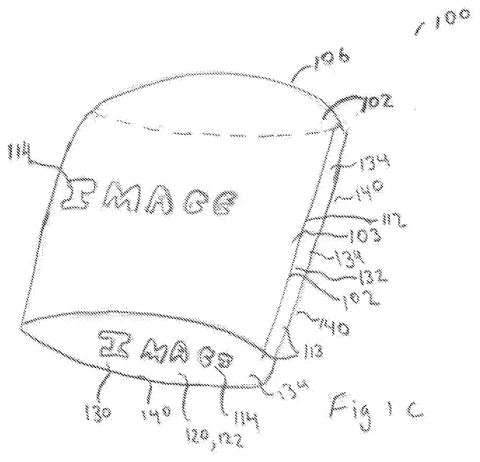

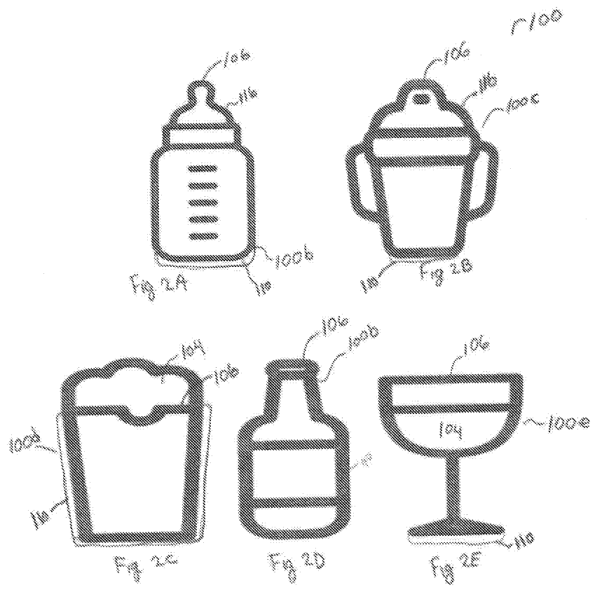

According to various embodiments, the drinking device 100 may be any type of drink ware. For example, drinking device 100 may be a cup 100a, as shown in FIGS. 1A-C. In some embodiments, as shown in FIGS. 2A-E, drinking device 100 may be a bottle 100b, including baby bottle, sports bottle, etc., lidded cup 100c, such as a Sippy cup, mug 100d, or wineglass 100e. In other embodiments, the disclosed drinking device 100 may be, for example, a shot glass, tumbler, coffee or tea cup, and the like.

According to various embodiments, the opening 106 may be provided directly on the container 102, and/or on an attachment 116 such as a lid, bottle nipple, straw, and the like. Typically, but not exclusively, such drinking devices may be cylindrical and/or conical, but other geometric configurations may also be adopted. Additionally, the disclosed drinking device may incorporate various features such as handles, lids, straws, connectors, etc.

According to various embodiments, the image element 110 may comprise a light source 120. In further embodiments, image element 110 may further comprise a power source 122 configured to power the light source 120. In further embodiments, the image element 110 may include at least one image overlay 124 configured to combine with the light source 120 in order to produce the image 114. In further embodiments, image element 110 may further comprise various optical elements 128. In further embodiments, image element 110 may further comprise a retaining element 118 configured to contain the light source 120. In embodiments, the retaining element may further contain the power source 122. In some embodiments, retaining element 118 may further contain the image overlay 124. In further embodiments, the light source 120, power source 122, and/or image overlay 124 may be removable and/or replaceable (interchangeable). Accordingly, a method of use of the drinking device may comprise interchanging/replacing the image overlay, and may further comprise replacing the power source and/or light source. In other embodiments, the light source 120, power source 122, and/or image overlay 124 may be permanently affixed or coupled to the drinking device/system.

According to various embodiments, the image 114 created by the image element may emanate from at least a portion of the container 102. In some embodiments, the image 114 may emanate from a bottom surface 130 of the container 102 (see FIG. 1A). In some embodiments, the image 114 may emanate from a side surface 132 of the container 102 (see FIG. 1B). In some embodiments, the image 114 may emanate from both the bottom surface 130 and the side surface 132 (see FIG. 1C).

According to various embodiments, the image 114 may present a meaningful representation (as opposed to light spot(s)/point(s)). For example, image 114 may comprise text, a logo, picture, sign, symbol, and the like. For example, image 114 may be a logo of a sports team, a company trademark, a name (e.g. name of the bride and groom at a wedding, party host, etc.), a message, a picture of an object, fictional character, animal, or person, etc. In some embodiments, the image 114 may comprise a single color of light, white light, black (i.e. a silhouette produced by a blocked portion of colored and/or white light), multiple colors of light, or combinations thereof. Additionally, in some embodiments, the image 114 may be configured to project onto a surface 126, such as a nearby wall, screen, or other object. In embodiments, image 114 may generally be a 2-dimensional image (noting that the surface from which the image 114 emanates may not necessarily be a flat surface). However, other types of images, such as 3-D, holographic, stereoscopic, moveable images, etc. are also contemplated.

In embodiments, light source 120 may comprise a lighting system such as light-emitting-diode (LED), laser including laser diode, incandescent, fluorescent, halogen, low pressure sodium lamp, and the like. Such lighting systems may provide white light, colored light, which may be monochromatic, diffused, divergent, directional, coherent, incoherent, etc. In embodiments, the light source 120 may be replaceable.

Additionally, power source 122 for powering light source 120 may comprise any type of battery suitable powering light source 120 (e.g. button cell, lithium, etc., which may be rechargeable and/or replaceable). In some embodiments, the power source 122 may include an on/off control element. Other power sources, which may be employed, may include a hand operated power generator, a solar cell, and the like. Other lighting systems and power sources, which are or may become available with emerging technology, may be utilized as well.

In some embodiments, the image 114 may be produced by the light source 120 itself, as for example, with a neon lighting system. In other embodiments, the image overlay 124 may work in conjunction with the light source 120 to produce the image 114. The image overlay 124 may be, for example, an image film 142 (i.e. slide), or a mask element 138. In some embodiments, the image overlay 124 may be removable and/or interchangeable, such that a user may change the image 114. In further embodiments, optical elements 128 may also be utilized to produce the image 114, which may be in conjunction with the image overlay 124. Optical elements may comprise, for example, reflector(s), condenser(s), and lens(es), or combinations thereof. Such optical elements 128 may be provided behind the light source 120, between the light source and overlay 124, and/or behind the overlay 124. In some embodiments, a heat-absorbing element may be used. In some embodiments, optical element 128 may also be heat absorbing. In some embodiments, a light source 120 that gives off heat may be utilized to serve an additional function of heating the beverage within the container, while providing decorative illumination.

Other optical elements may include, but are not limited to filter(s), beam splitter(s), diffraction grating, liquid crystal, and/or holographic elements may be utilized. In some embodiments, a computer chip may be used to create and/or control the image 114. Other optical elements, including those for projector technology, and arrangement of such elements, which are or may become available with emerging technology may also be employed.

According to various embodiments, the image overlay 124 may be provided within the retaining element 118, and/or outside the retaining element 118. Additionally, the image overlay 124 may be permanently affixed or incorporated to the drinking device 100, according to some embodiments, while in other embodiments the image overlay 124 may be removable and/or interchangeable.

According to various embodiments, the retaining element 118 may comprise a first wall 140 surrounding at least a portion of the container 102, and forming a compartment against the outer surface of the container wall (i.e. on the outer side of the container). In embodiments, compartment 134 may be formed between the outer surface 112 of the container wall 103, and first wall 140. In some embodiments, the retaining element may include a second wall 141, wherein compartment 134 is formed between the first wall 140 and second wall 142. In some embodiments, the retaining element 118 may be permanently attached to the container 102. In other embodiments, the retaining element 118 may be detachable. In embodiments, walls 140, 141, may be parallel to, and in line with the container wall 103. As such, the shape of the drinking device 100, and size of the container 102 may be unchanged by virtue of the retaining element 118. Additionally, the size of the container 134 is preferably large enough to encapsulate the light source 120 and power source 122.

In some embodiments, the compartment 134 may be formed adjacent to the bottom surface 130 of the container 102 (see FIG. 1A). In some embodiments, compartment 134 may be formed adjacent to the side surface 132 (see FIG. 1B). In some embodiments, the compartment 134 may be formed adjacent to both the bottom surface 130 and side surface 132 (See FIG. 1C). It is noted that in some embodiments, an image element located immediately adjacent the bottom surface 130, but not the side surface 132 (as in FIG. 1A) may also light up the side surface 132 (for example, a transparent container), and visa versa. Therefore, according to some embodiments, an image may be produced at a surface does not necessarily require an immediately adjacent image element.

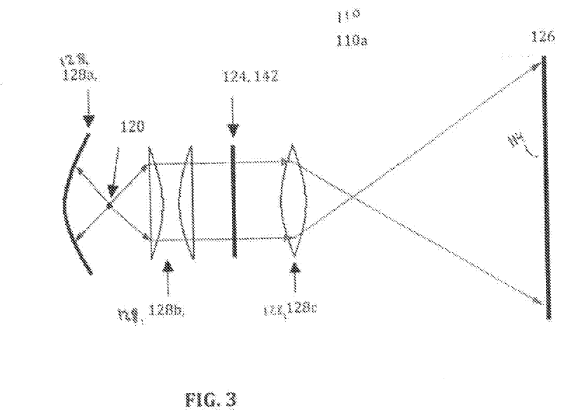

Shown in FIG. 3 is a schematic of an image element 110a, according to an exemplary embodiment, which includes an overlay 124 comprising an image film 142 (i.e. slide), and optical elements 128, configured to project the image presented in the film 142 onto a surface. According to various embodiments, the film 142 (or slide) may comprise an image on a substrate having a degree of transparency, such that light shown through the film 142 may cause the image to be seen and/or to project onto a surface. As shown in the figure, the optical elements may include a reflector 128a, which may be a concave reflector or mirror, positioned behind the light source 120, a condenser 128b, configured to concentrate light onto the film 142, positioned between the light source and film 142, and a focus lens 128c positioned in front of the film 142. According to various embodiments, the light source 120 may be provided within the retaining element 118 which may be adjacent the side 130 and/or bottom surface 132 of container 102. According to various embodiments, other components of the image element 110a, including film 142 and optical elements 128a, 128b, and/or 128c may be provided within retaining element 118, or may form a wall of the retaining element. For example, the focus lanes 128c may form the first wall 140 of the retaining element.

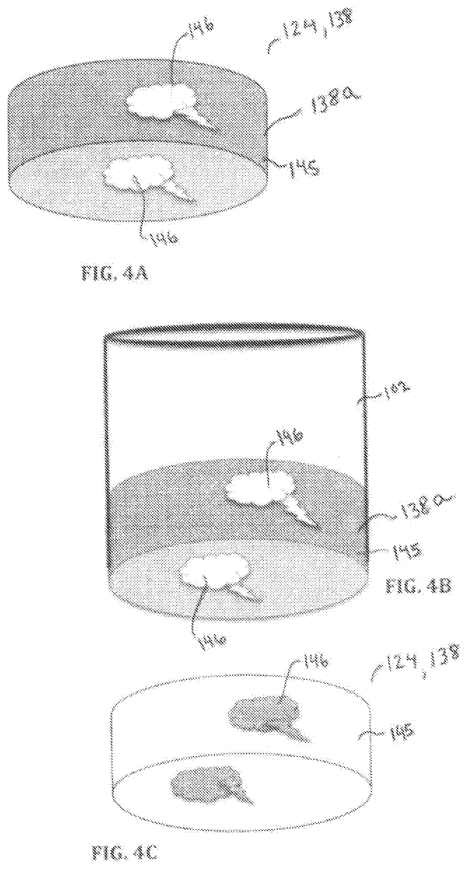

Shown in FIGS. 4A-E are examples of an image element which includes an overlay 124 comprising a mask 138. According to various embodiments, the mask 138 may comprise an opaque sheet 145 from which the image 114 has been cut out (see FIGS. 4A and B). In other embodiments, the mask 138 may itself be an opaque form of the image 114 (see FIGS. 4C, D, and E), such that light may be emitted around the image to produce a silhouette of the image 114. An image 114 which is opaque may be stand alone (see FIGS. 4 D and E), and/or provided on a support surface or transparent sheet (see FIG. 4C). Additionally, the mask 138 may be configured to fit over at least a portion of the drinking device 100 which is lit up by the light source 120. According to various embodiments, the mask 138 may be configured to overlay the side surface 132 and/or bottom surface 130 of the container 102.

According to various embodiments, the masks 138, sheet 145 may be formed from a flexible material such as rubber. Other materials which may form the mask may be flexible or inflexible, and may comprise various metals, plastics, rubbers, cloths (real or synthetic textiles), and the like. In some embodiments, the mask 138 may provide a secondary benefit such as a gripping surface and/or insulation. In some embodiments, the mask my incorporate an element such as a handle.

In one embodiment, the mask 138 may be configured as a ‘sleeve’ (without a bottom section) to overlay only the side surface 132 of the container 102. According to various embodiments, such sleeve-type mask may be made of a flexible and stretchy material (cloth, for example), and may be used as an ornamental and/or functional cover over various objects such as a user's arm, guitar neck, a car gear-shift, etc. Functional benefits of the sleeve-type mask may include increase of surface grip, warming a cold surface (such as the stick shift of a car), protecting an item (such as the guitar neck), entertaining a child (by wearing the ‘sleave’), etc. Other uses and benefits may be apparent to one skilled in the art.

FIGS. 4A and B illustrate a mask 138a according to an exemplary embodiment wherein the opaque sheet 145 includes a cutout 146 of the image 114 (clouds and lightning bolts, for purpose of illustration). The mask 138a is shown in the figure is a cylindrical sheet configured to fit over a cylindrical drinking device, and cover the bottom and at least a portion of the side of the drinking device. However, such mask may be configured to cover only the side or only the bottom portion, according to various embodiments. As illustrated, the mask 138a has cutouts of the clouds and lightning bolts image on both the bottom and side of the mask. As such, light will pass only through those cutout sections to provide a lighted image of clouds and lightning bolts. In an alternate embodiment, the clouds and lightning bolt image may be opaque, while the surrounding sheet 145 may be substantially transparent, as shown in FIG. 4C.

FIGS. 4D and E illustrates a mask 138b wherein the opaque sheet 145 itself forms the image 114 (“waves,” for purpose of illustration) in sand alone form. According to the embodiment shown, the mask 138b may be configured to fit around the drinking device 100, wherein the light source 120 of the image element 110 may be provided adjacent to the bottom surface 130 of the container 102 and/or adjacent to the side surface 132. Additionally, the mask 138b may be made of a rigid material, such as a metal. Thus, a silhouette of the waves image will be produced.

In some embodiments, light source 120 may be attached to the sleeve 138 itself. In some embodiments, a sleeve with attached light source 120 may include an image element 110 on the sleeve 138. In some embodiments, a sleeve with attached light source 120 may not include an image element 110. Such sleeve with lighting element may be configured to wrap around an object and provide lighting.

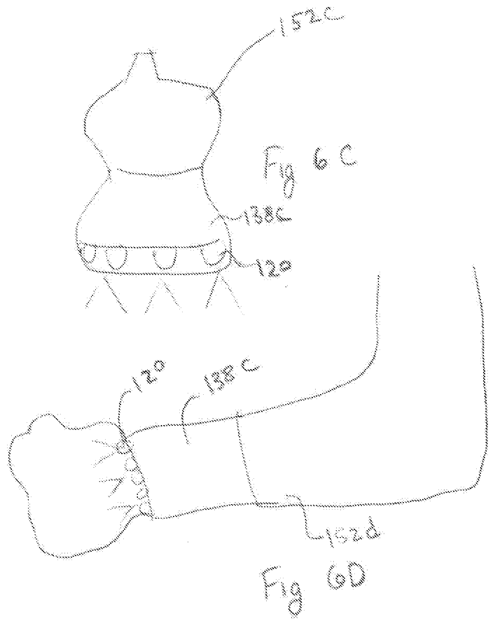

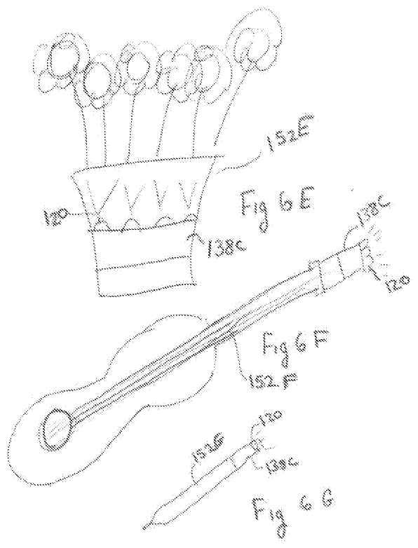

FIGS. 6A-G illustrate a sleeve type mask 138c, which comprises a wrap around band with light source 120. In some embodiments, light source 120 may comprise LED lights, which may protrude from an outer edge of the mask 138c (see FIG. 6A). In further embodiments, the mask 138c may further comprise a power source such as a battery 153.

According to various embodiment, the mask 138c may include an attachment element 150, such as Velcro, which enables the band to enclose around various objects, and adjust to the objects size. Other closure mechanisms may include, for example, buttons, buckles, and the like. In some embodiments, mask 138c may be a bistable spring band such as a “snap” or “slap” band. FIGS. 6B-G illustrates mask 138c wrapped around a variety of objects including a bottle 152b (see FIG. 6B), Sippy Cup 152c (see FIG. 6c), user's arm 152d (see FIG. 6D), flower vase 152e (see FIG. 6E), guitar neck 152f (see FIG. 6F), Pen 152g (see FIG. 6G), and the like.

It is noted that while the mask 138c is shown as not having an image element, in some embodiments, an image element may be provided, as described, for example in FIGS. 4A-E. For example, mask 138c may include a cutout image or may be formed as a design of the image.

Various uses of the disclosed drinking device 100 may include providing decorative illumination, entertainment, lighting, etc. The disclosed drinking device 100 may be used, for example, at an event such as a wedding, birthday, or office party, wherein the image may be related to the event (e.g. name or picture of the party host(s), message of congratulations, company logo, etc.). As another example, the disclosed drinking device 100 may be used for entertaining an infant, e.g. by providing a light up image on a baby bottle or Sippy cup, wherein the image may appear on a wall, as the infant is drinking. The illumination provided may further serve as a night-light or other functional illumination.

It should be readily understood that while the disclosed embodiments are generally illustrated with respect to a cup type drinking device, the disclosure may apply to other types of drinking devices, such as those shown in FIGS. 2 A-E, etc.

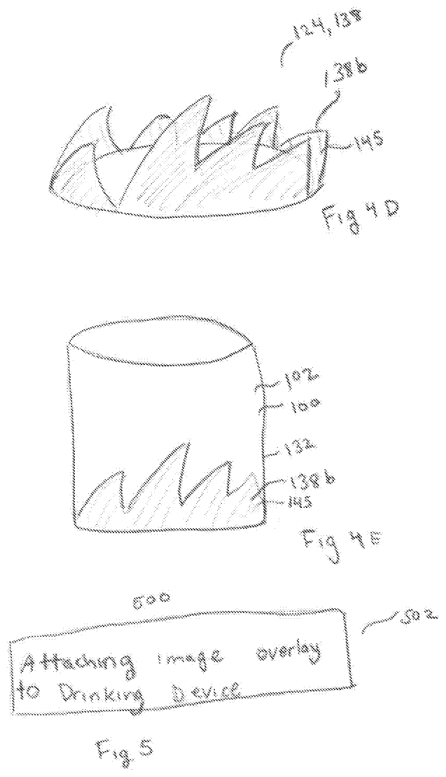

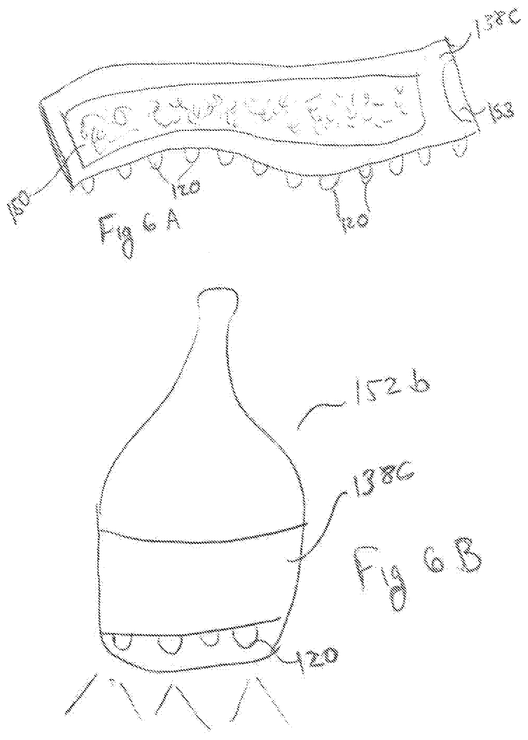

FIG. 5 outlines a drinking method 500 comprising: attaching an image overlay to a drinking device (step 502), such as the drinking device 100, wherein the drinking device is configured to emit an image via said image overlay, wherein said image may be emitted while the drinking device is filled with a liquid, and while a user drinks the liquid. The drinking device 100 may further comprise a light source and a power source configured to power the light source, wherein the image overlay is configured to combine with the light source in order to produce said image.

What is claimed is:

1. A drinking device comprising:
a container configured to contain a liquid, and providing an opening from which said liquid can exit the container, the container being formed from at least one container wall having an outer surface;
an image element, configured to emit a defined image, the image element attached or configured for attachment to the outer surface of said container, such that said liquid within said container is prevented from contact with said image element,
the image element including a light source, a power source configured to power the light source, and an image overlay configured to combine with the light source in order to produce the image,
wherein said image or design may be emitted while the drinking device is filled with a liquid, and while a user drinks the liquid.

2. The drinking device of claim 1, wherein the image comprises at least one of a textual image, a logo, picture, sign, symbol, or combinations thereof.

3. The drinking device of claim 2, wherein the image is configured to project onto a surface outside of the drinking device.

4. The drinking device of claim 1, wherein the image overlay is removable and/or interchangeable.

5. The drinking device of claim 1, wherein the image overlay comprises a film.

6. The drinking device of claim 5, wherein the image element further comprise at least one optical element including at least one of a lens, reflector, or condenser.

7. The drinking device of claim 1, wherein the image overlay comprises a mask configured to fit over at least a portion of the drinking device.

8. The drinking device of claim 7, wherein the mask is formed from a flexible material.

9. The drinking device of claim 7, wherein the mask is formed from a metal, plastic, or rubber material.

10. The drinking device of claim 7, wherein the mask comprises an opaque sheet having a cutout, wherein the image is formed according to the cutout.

11. The drinking device of claim 7, wherein the mask comprises an opaque form of the image.

12. The drinking device of claim 1, further comprising a retaining element for encapsulating at least a portion of said image element, the retaining element including at least one retainer wall surrounding at least a portion of said container wall, said retainer wall being parallel to said container wall and forming a compartment against the outer surface of said container wall.

13. The drinking device of claim 1, wherein the light source comprises LED lights.

14. A drinking device comprising:
a container configured to contain a liquid, and providing an opening from which said liquid can exit the container, the container being formed from at least one container wall having an outer surface;
an image element, configured to emit a defined image comprising at least one of a textual image, a logo, picture, sign, symbol, or combinations thereof, the image element attached or configured for attachment to the outer surface of said container, such that said liquid within said container is prevented from contact with said image element,
the image element including a light source, and a power source configured to power the light source, wherein said image or design may be emitted while the drinking device is filled with a liquid, and while a user drinks the liquid.

15. The drinking device of claim 14, wherein the image is configured to project onto a surface outside of the drinking device.

16. The drinking device of claim 14, wherein the image element further comprise at least one optical element including at least one of a lens, reflector, or condenser.

17. The drinking device of claim 14, further comprising a retaining element for encapsulating at least a portion of said image element, the retaining element including at least one retainer wall surrounding at least a portion of said container wall, said retainer wall being parallel to said container wall and forming a compartment against the outer surface of said container wall.

18. The drinking device of claim 1, wherein the light source comprises LED lights.

19. A wrap around lighting element comprising:
a band, configured to wrap around an object, the band comprising a lighting element.

20. The wrap around lighting element of claim 19, further comprising:
A closure element, and a power source for the lighting element,
wherein the lighting element comprises LED lights attached to the band.
